(19) United States
(12) Patent Application Publication
(10) Pub. No.: US 2025/0181825 A1
(43) Pub. Date: Jun. 5, 2025

(54) INFORMATION PROCESSING METHOD, INFORMATION PROCESSING APPARATUS, AND PROGRAM THAT COMBINES MULTIPLE COOKING STEPS

(71) Applicant: Panasonic Intellectual Property Corporation of America, Torrance, CA (US)

(72) Inventors: Keiichi TOIYAMA, Osaka (JP); Saeko SHINGU, Osaka (JP); Kenta MURAKAMI, Osaka (JP); Kihiro YUASA, Kanagawa (JP)

(73) Assignee: Panasonic Intellectual Property Corporation of America, Torrance, CA (US)

(21) Appl. No.: 19/045,345

(22) Filed: Feb. 4, 2025

Related U.S. Application Data
(63) Continuation of application No. PCT/JP2023/029812, filed on Aug. 18, 2023.

(30) Foreign Application Priority Data
Aug. 22, 2022 (JP) 2022-132076

(51) Int. Cl. G06F 40/166; G06F 40/289

(52) U.S. Cl. CPC G06F 40/166; G06F 40/289

(57) ABSTRACT

An acquisition unit acquires a plurality of first cooking steps and a plurality of second cooking steps. An output unit outputs, based on an instrument used in the plurality of first cooking steps and the plurality of second cooking steps, aggregated step data indicating an aggregated step comprised of a mixture of the plurality of first cooking steps and the plurality of second cooking steps such that an overall cooking time is shorter than a total of a step comprised of a combination of the plurality of first cooking steps and the plurality of second cooking steps. The aggregated step includes, between steps derived from dividing a given first cooking step, a second cooking step that uses the same instrument as the given first cooking step.

This application is based upon and claims the benefit of priority from the prior Japanese Patent Application No. 2022-132076, filed on Aug. 22, 2022, the entire contents of which are incorporated herein by reference.

### BACKGROUND

### 1. Field

The present disclosure relates to information processing technology and particularly to an information processing method, an information processing apparatus, and a program that combines a plurality of cooking steps.

### 2. Description of the Related Art

Food prepared for a meal tastes better when eaten immediately after cooking. Therefore, one may cook food according to a plurality of recipes simultaneously and in parallel. Depending on the schedule of the user, however, the user may wish to interrupt cooking in the middle of a cooking step. As a method for interrupting cooking, Patent Literature 1, for example, discloses a method and a program for determining whether interruption in a cooking step is possible depending on whether the cooked food obtained by the cooking step is suitable for storage.
[Patent Literature 1] JP 2017-4250

Patent Literature 1 discloses a method and a program for determining whether interruption in a cooking step is possible depending on whether the cooked food obtained by the cooking step is suitable for storage. In the case one cooks the food according to a plurality of recipes, however, it is not possible to shorten the overall cooking time while also interrupting cooking properly.

### SUMMARY

The present disclosure addresses the issue described above, and a purpose thereof is to provide a technology for reducing overall cooking time in the case one cooks the food according to a plurality of recipes.

An information processing method according to an embodiment of the present disclosure includes: acquiring a plurality of first cooking steps and a plurality of second cooking steps; and outputting, based on an instrument used in the plurality of first cooking steps and the plurality of second cooking steps, aggregated step data indicating an aggregated step comprised of a mixture of the plurality of first cooking steps and the plurality of second cooking steps such that an overall cooking time is shorter than a total of a step comprised of a combination of the plurality of first cooking steps and the plurality of second cooking steps, wherein the aggregated step includes, between steps derived from dividing a given first cooking step, a second cooking step that uses the same instrument as the given first cooking step.

Another embodiment of the present disclosure also relates to an information processing apparatus. The apparatus includes: an acquisition unit that acquires first recipe data indicating a plurality of first cooking steps and second recipe data indicating a plurality of second cooking steps; and an output unit that outputs, based on an instrument used in the plurality of first cooking steps and the plurality of second cooking steps, aggregated step data indicating an aggregated step comprised of a mixture of the plurality of first cooking steps and the plurality of second cooking steps such that an overall cooking time is shorter than a total of a step comprised of a combination of the plurality of first cooking steps and the plurality of second cooking steps, wherein the aggregated step includes, between steps derived from dividing a given first cooking step, a second cooking step that uses the same instrument as the given first cooking step.

Optional combinations of the aforementioned constituting elements, and implementations of the disclosure in the form of methods, apparatuses, systems, recording mediums, and computer programs may also be practiced as additional modes of the present disclosure.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a configuration of an information processing system according to an embodiment;

FIG. 2 shows a configuration of the information processing apparatus of FIG. 1;

FIGS. 3A-3B show a data structure of recipe data stored in the step information storage unit of FIG. 2;

FIG. 4 shows a data structure of a first candidate of the aggregated step data created in the aggregated step candidate calculation unit of FIG. 2;

FIG. 5 shows a data structure of a second candidate of the aggregated step data created in the aggregated step candidate calculation unit of FIG. 2;

FIG. 6 shows a data structure of a third candidate of the aggregated step data created in the aggregated step candidate calculation unit of FIG. 2;

FIG. 7 is a flowchart showing a procedure for creating aggregated step data by the information processing apparatus of FIG. 2;

FIG. 8 shows a data structure of a table stored in the table storage unit according to variation 2;

FIG. 9 shows a data structure of a table stored in the table storage unit according to variation 3;

FIG. 10 shows a data structure of a table stored in the table storage unit according to variation 4;

FIG. 11 shows a data structure of another table stored in the table storage unit according to variation 4;

FIG. 12 shows a data structure of another table stored in the table storage unit according to variation 6; and

FIG. 13 shows a configuration of the information processing system according to variation 7.

### DETAILED DESCRIPTION

The invention will now be described by reference to the preferred embodiments. This does not intend to limit the scope of the present invention, but to exemplify the invention.

All of the embodiments described below illustrate preferred embodiments of the present disclosure. Therefore, numerical values, shapes, materials, constituting elements, positions of arrangement and connection forms of constituting elements, and steps and order of steps shown in the following embodiments are examples only and are not presented to limit the present disclosure. Therefore, those of the components in the following embodiments not defined in the independent claims, which present the highest-level concept of the present disclosure, are described as optional constituting elements. Substantially identical features illustrated in the figures are denoted by identical symbols, and a duplicate description is omitted or simplified.

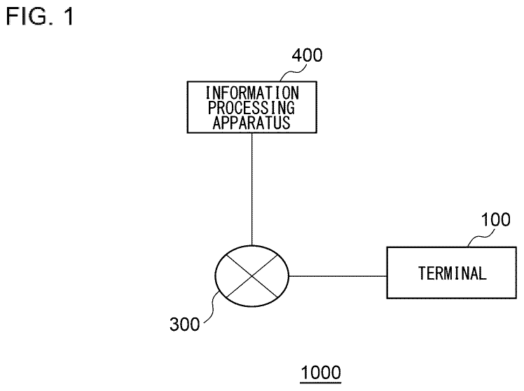

FIG. 1 shows a configuration of an information processing system 1000. The information processing system 1000 includes a terminal 100, a network 300, and an information processing apparatus 400. The terminal 100 and the information processing apparatus 400 are connected via a network 300 such as the Internet. In the information processing system 1000, the information processing apparatus 400 creates recipe data (hereinafter referred to as “aggregated step data”) derived from mixing data for a plurality of recipes (hereinafter referred to as “recipe data”), and the information processing apparatus 400 provides, via the network 300, the aggregated step data thus created to the terminal 100 used by the user. The number of terminals 100 included in the information processing system 1000 is not limited to “1”.

The terminal 100 is an apparatus having a communication function that can be connected to the network 300 and is used by the user. The terminal 100 is, for example, a computer, a smartphone, a tablet terminal, a cooking utensil, etc. The terminal 100 includes a user control interface (not shown) such as a button that can receive information input by the user and a display unit (not shown) such as a display that can display information to the user. The user control interface and the display unit may be integrated as a touch panel. The terminal 100 selects a plurality of items of recipe data for a meal according to an instruction from the user and transmits information on the plurality of items of recipe data thus selected (hereinafter referred to as “selection information”) to the information processing apparatus 400 via the network 300. Further, the terminal 100 receives the aggregated step data from the information processing apparatus 400 via the network 300 and displays the aggregated step data.

The information processing apparatus 400 is an apparatus having a communication function that can be connected to the network 300 and is, for example, a computer such as a server and a cloud server equipped with a processor, a memory, etc. The information processing apparatus 400 receives the selection information from the terminal 100 via the network 300. The information processing apparatus 400 selects a plurality of items of recipe data corresponding to the selection information, creates the aggregated step data by mixing the plurality of items of recipe data, and transmits the aggregated step data to the terminal 100 via the network 300.

In this embodiment, “meal” is a unit for ingesting food such as dinner and breakfast at one time. Snacks may be included in the meal. “Dish” is a unit of food with a dish name, such as miso soup and Hamburg steak. A meal includes one or more dishes. Normally, one dish is served in one plate, but those dishes, such as “Hamburg stake” and “salad”, that can be served alone as a meal even if the other is missing are respectively considered as a dish. On the other hand, those dishes, such as “Hamburg steak (meat part)” and “Hamburg sauce”, that cannot be a served alone as a dish or a meal if the other is missing are collectively considered as a dish. “Cooking” refers to the action of cooking.

“Dish” is cooked according to a recipe that describes a cooking procedure. As mentioned above, data for recipe is called “recipe data”. In the recipe data, a plurality of “cooking steps” are arranged in the order of actions. A cooking step is a unit of cooking action that is roughly divided and is exemplified by cutting or simmering of a cooking ingredient. Such recipe data is generally provided for each “dish”. In the case of “Hamburg steak (meat part)” and “Hamburg sauce” which are considered to form one dish, however, the recipe data for “Hamburg steak (meat part)” and the recipe data for “Hamburg sauce” are provided separately.

In the recipe data, a restriction is imposed to prevent from proceeding to the next cooking step unless the previous cooking step is completed. However, such a restriction is not provided in cooking steps across a plurality of items of recipe data. That is, cooking steps across a plurality of items of recipe data can be executed at the same time. In the case of Hamburg stake, for example, it is possible to make a sauce while the Hamburg stake is being grilled.

“Aggregated step data” is, as described above, data obtained by mixing a plurality of items of recipe data. The aggregated step data indicates a procedure for cooking steps that should be executed to prepare a meal. In the aggregated step data, the order of and timing to start each cooking step are shown across multiple items of recipe data.

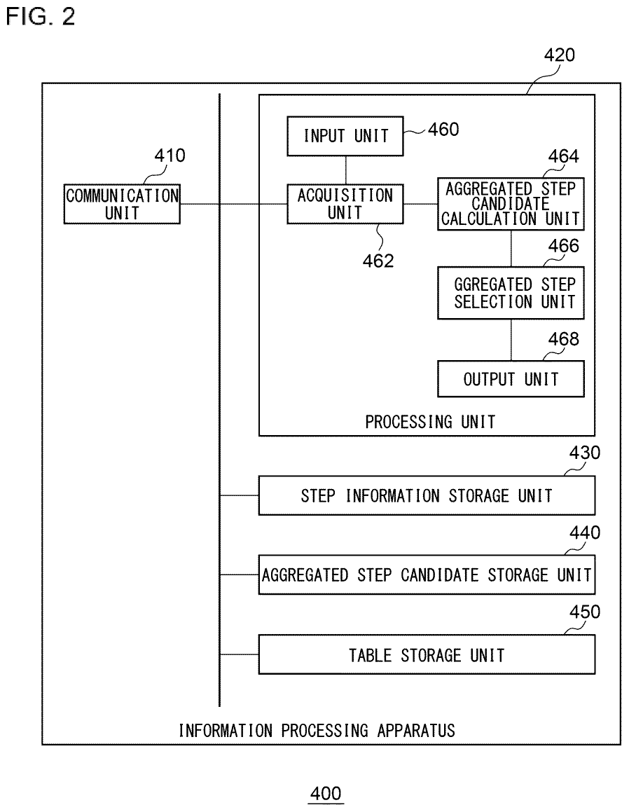

FIG. 2 shows a configuration of the information processing apparatus 400. The information processing apparatus 400 includes a communication unit 410, a processing unit 420, a step information storage unit 430, an aggregated step candidate storage unit 440, and a table storage unit 450. The processing unit 420 includes an input unit 460, an acquisition unit 462, an aggregated step candidate calculation unit 464, an aggregated step selection unit 466, and an output unit 468. The step information storage unit 430, the aggregated step candidate storage unit 440, and the table storage unit 450 are an HDD (HardDiskDrive) or an SSD (SolidStateDrive) and can store electronic information. The communication unit 410 performs communication with the terminal 100 via the network 300.

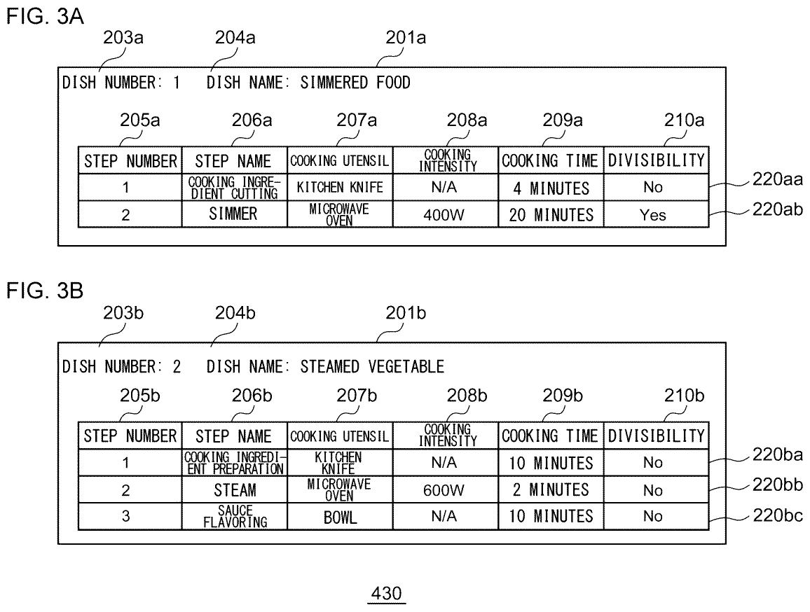

The step information storage unit 430 stores a plurality of items of recipe data linked with dishes. As described above, the recipe data includes a plurality of cooking steps. FIGS. 3A-3B show a data structure of the recipe data 201 stored in the step information storage unit 430. FIG. 3A shows first recipe data 201a, and FIG. 3B shows second recipe data 201b. The first recipe data 201a and the second recipe data 201b are collectively referred to as recipe data 201. The number of types of recipe data 201 stored in the step information storage unit 430 is not limited to “2”.

The first recipe data 201a of FIG. 3A is identified by a first dish number 203a and a first dish name 204a. Further, the first recipe data 201a includes a 1-1-th cooking step 220aa and a 1-2-th cooking step 220ab. In each of the 1-1-th cooking step 220aa and the 1-2-th cooking step 220ab, a first step number 205a, a first step name 206a, a first cooking utensil 207a, a first cooking intensity 208a, a first cooking time 209a, and a first divisibility 210a are stored.

The second recipe data 201b of FIG. 3B is identified by a second dish number 203b and a second dish name 204b. Further, the second recipe data 201b includes a 2-1-th cooking step 220ba, a 2-2-th cooking step 220bb, and a 2-3-th cooking step 220bc. In each of the 2-1-th cooking step 220ba, the 2-2-th cooking step 220bb, and the 2-3-th cooking step 220bc, a second step number 205b, a second step name 206b, a second cooking utensil 207b, a second cooking intensity 208b, a second cooking time 209b, and a second divisibility 210b are stored.

The first dish number 203a and the second dish number 203b are collectively referred to as a dish number 203, and the first dish name 204a and the second dish name 204b are collectively referred to as a dish name 204. The 1-1-th cooking step 220aa, the 1-2-th cooking step 220ab, the 2-1-th cooking step 220ba, the 2-2-th step 220bb, and the 2-3-th cooking step 220bc are collectively referred to as a cooking step 220. When the cooking step 220 included in the first recipe data 201a is referred to as the “first cooking step”, the cooking step 220 included in the second recipe data 201b is referred to as the “second cooking step”. The first step number 205a and the second step number 205b are collectively referred to as a step number 205, the first step name 206a and the second step name 206b are collectively referred to as a step name 206, and the first cooking utensil 207a and the second cooking utensil 207b are collectively referred to as a cooking utensil 207 (instrument). The first cooking intensity 208a and the second cooking intensity 208b are collectively referred to as a cooking intensity 208, the first cooking time 209a and the second cooking time 209b are collectively referred to as a cooking time 209, and the first divisibility 210a and the second divisibility 210b are collectively referred to as a divisibility 210.

The number of cooking steps 220 included in the recipe data 201 is not limited to “2” or “3”. The step number 205 indicates the order of execution of cooking. In each recipe data 201, the steps are executed in order, starting from the cooking step 220 having the step number 205 of the smallest value. When the cooking step 220 having the step number 205 of the largest value is completed, cooking is completed.

A description will now be given of a step of simmering a cooking ingredient by using the first recipe data 201a of FIG. 3A. In the first recipe data 201a, the first dish number 203a is “1”, and the dish name 204 is “simmered food”. In this cooking step, the 1-1-th cooking step 220aa having the first step number 205a of the smallest number “1” is selected. In the 1-1-th cooking step 220aa, the step of “cooking ingredient cutting” in the field of the first step name 206a is executed. In that step, the cooking ingredient is cut using the “kitchen knife” indicated in the field of the first cooking utensil 207a. The field “N/A” of the first cooking intensity 208a indicates that there is no information relevant to the first cooking intensity 208a. Further, the time required for cutting the cooking ingredient is “4 minutes” as described in the field of the first cooking time 209a.

When the process of cutting the cooking ingredient is completed, the 1-2-th cooking step 220ab having the first step number 205a of the next smallest value “2” is selected. In the 1-2-th cooking step 220b, the step of “simmering” in the field of the first step name 206a is executed. In this step, the “microwave oven” indicated in the field of the first cooking utensil 207a is used, and “400 W” indicated in the field of the first cooking intensity 208a and “20 minutes” indicated in the field of the first cooking time 209a are set in the microwave oven. Thus, the cooking utensil 207 to be used is stored in association with each of the plurality of cooking steps 220. Since “2” is the maximum value of the first step number 205a, cooking is completed when the 1-2-th cooking step 220ab is completed.

The first divisibility 210a stored according to each cooking step 220 indicates whether the cooking step 220 is divisible. For example, the first divisibility 210a of the 1-1-th cooking step 220aa is “No” so that the 1-1-th cooking step 220a is not divisible. Meanwhile, the first divisibility 210a of the 1-2-th cooking step 220ab is “Yes” so that the 1-2-th cooking step 220a is divisible. The second recipe data 201b is interpreted and used for cooking in the same manner as the first recipe data 201a.

The divisible cooking step 220 indicated by the divisibility 210 “Yes” is a cooking step 220 for which the cooked food is not significantly deteriorated even if the cooking step 220 is interrupted. This can be said to be a step for which, in the case the cooking step 220 is interrupted, the cooked food can be finished to a complete state that meets a predefined standard once the entire cooking step 220 is completed. Significant deterioration is a change such as loss of taste, significant change in temperature, change in the amount of water (absorption of water or dryness), and change in shape (melting, hardening). For example, boiling vegetables can be interrupted, but boiling noodles cannot be interrupted because noodles become soggy. Further, the step of baking cakes or puff pastries in an oven cannot be interrupted because, if it is interrupted, the dough will deflate, and the shape of the finished product will be poor. Reference is made back to FIG. 2.

The input unit 460 receives the selection information from the terminal 100 via the communication unit 410 and the network 300. For example, the selection information indicates that the first recipe data 201a for cooking a simmered food and the second recipe data 201b for cooking steamed vegetables are selected. The acquisition unit 462 acquires the selected recipe data 201 from the step information storage unit 430. Specifically, the first recipe data 201a and the second recipe data 201b are acquired.

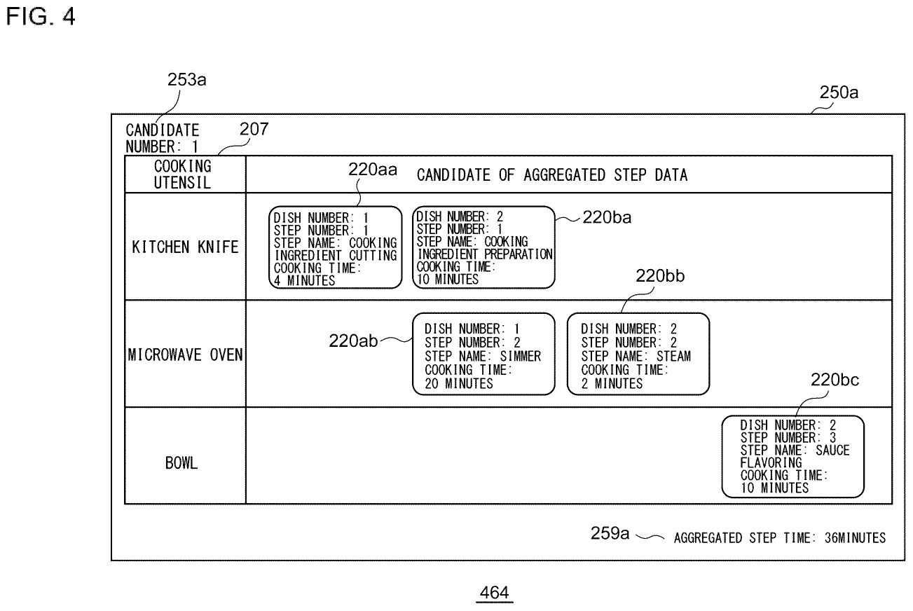

The aggregated step candidate calculation unit 464 creates a candidate of aggregated step data by combining the cooking step 220 included in the first recipe data 201a and the cooking step 220 included in the second recipe data 201b. The aggregated step data is created on the premise that the dishes included in the first recipe data and the second recipe data are cooked simultaneously and in parallel. FIG. 4 will also be used to illustrate creation of a candidate of aggregated step data. FIG. 4 shows a data structure of a first candidate 250a of the aggregated step data created in the aggregated step candidate calculation unit 464. The aggregated step candidate calculation unit 464 organizes each of the plurality of cooking steps 220 included in the first recipe data 201a and each of the plurality of cooking steps 220 included in the second recipe data 201b according to each cooking utensil 207. Also, the aggregated step candidate calculation unit 464 arranges the cooking steps 220 such that the step number 205 increases in the first recipe data 201a and arranges the cooking steps 220 such that the step number 205 increases in the second recipe data 201b. Further, the aggregated step candidate calculation unit 464 creates a first candidate 250a by combining the cooking steps 220 of the first recipe data 201a and the cooking steps 220 of the second recipe data 201b in the same cooking utensil 207. The first candidate 250a is identified by a first candidate number 253a.

To describe it more specifically, the aggregated step candidate calculation unit 464 checks the first recipe data 201a and the second recipe data 201b of FIG. 4 and recognizes that the first cooking utensil 207a and the second cooking utensil 207b include three utensils, i.e., “kitchen knife”, “microwave oven”, and “bowl”. The aggregated step candidate calculation unit 464 secures a storage area for each cooking utensil 207.

The aggregated step candidate calculation unit 464 arranges the cooking steps 220 included in the first recipe data 201a and the second recipe data 201b in the storage area for each cooking utensil 207 secured. In this process, for example, the 2-3-th cooking step 220bc is the only step that uses the bowl, but the 2-3-th cooking step 220bc cannot be arranged to precede the 2-2-th cooking step 220bb because the cooking steps 220 must be arranged such that the step number 205 of each recipe data 201 increases. That is, until the cooking step 220, of the plurality of cooking steps 220 included in the recipe data 201, of a given step number 205 is completed, the cooking step 220 of the step number 205 next to the given step number 205 cannot be executed. That is, the cooking step 220 having the step number 205 of n (n is an integer equal to or larger than 1) cannot be executed until cooking in the cooking step 220 having the step number 205 of (n−1) is completed. On the other hand, a restriction on the order of the step number 205 is provided for each recipe data 201. Therefore, the 2-3-th cooking step 220bc may be arranged to precede the 1-1-th cooking step 220aa and the 1-2-th cooking step 220ab.

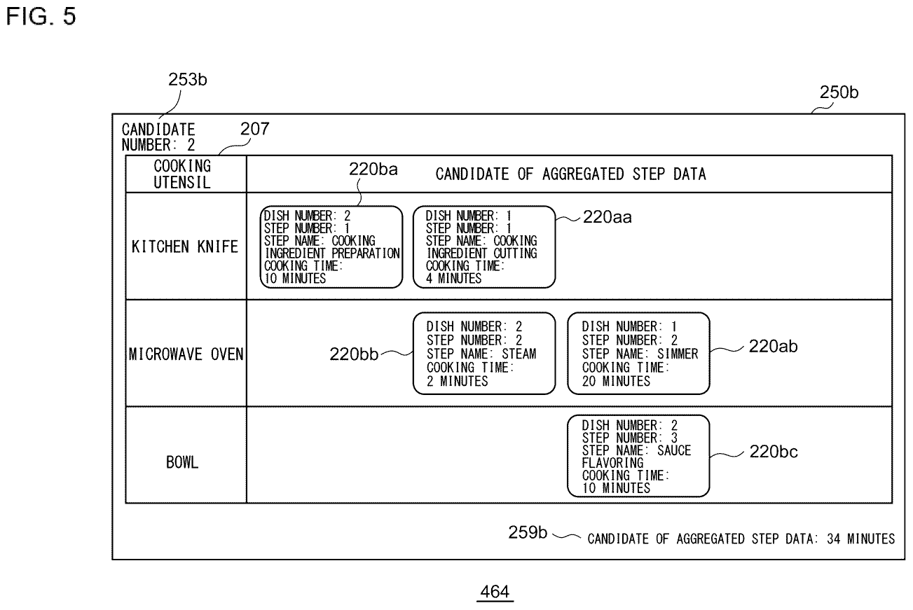

FIG. 5 shows a data structure of a second candidate 250b of the aggregated step data created in the aggregated step candidate calculation unit 464. The recipe data 201 may not be executed in the order of the dish number 203 so that the aggregated step candidate calculation unit 464 may arrange the cooking step 220 of the second recipe data 201b earlier, when combining the cooking step 220 of the first recipe data 201a and the cooking step 220 of the second recipe data 201b. Consequently, the second candidate 250b is created. The second candidate 250b is identified by a second candidate number 253b. Reference is made back to FIG. 2.

In the case the cooking step 220 included in the first recipe data 201a and the cooking step 220 included in the second recipe data 201b use the same cooking utensil 207, the aggregated step candidate calculation unit 464 checks whether the cooking step 220 included in the first recipe data 201a or the second recipe data 201b is divisible. In this example, the first divisibility 210a in the 1-2-th cooking step 220ab in the first recipe data 201a shown in FIG. 3A is “Yes”, the aggregated step candidate calculation unit 464 recognizes that the 1-2-th cooking step 220ab is divisible. In this case, division into two parts is assumed, but the embodiment is not limited thereto.

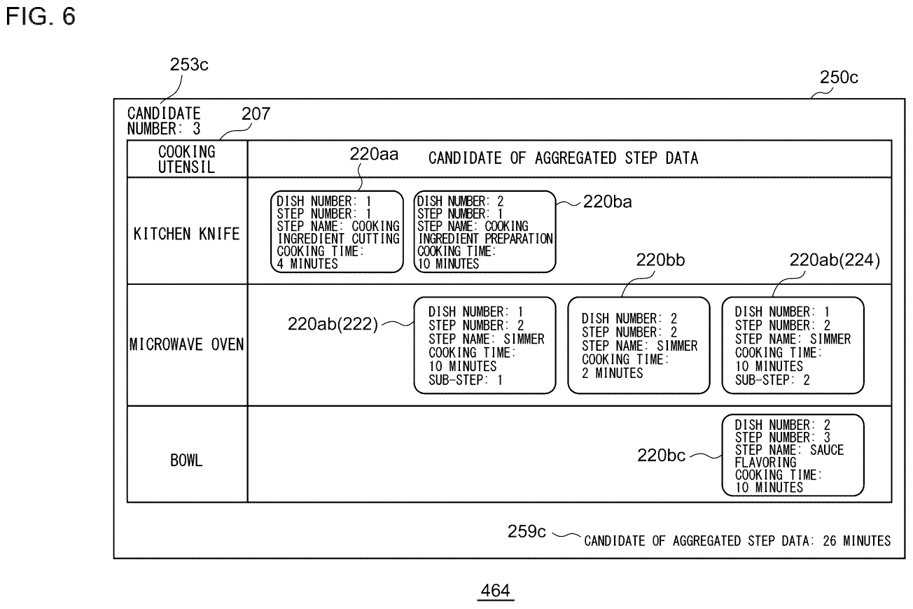

When there is a divisible cooking step 220, the aggregated step candidate calculation unit 464 creates a candidate of the aggregated step data by dividing the divisible cooking step 220 and sandwiching the cooking step 220 included in a further recipe data 201 between divided steps. In this case, FIG. 6 is also used to illustrate creation of a candidate for the aggregated step data. FIG. 6 shows a data structure of a third candidate 250c of the aggregated step data created in the aggregated step candidate calculation unit 464. The aggregated step candidate calculation unit 464 organizes each of the plurality of cooking steps 220 included in the first recipe data 201a and each of the plurality of cooking steps 220 included in the second recipe data 201b according to each cooking utensil 207 as already described. Since the 1-2-th cooking step 220ab is divisible, the aggregated step candidate calculation unit 464 divides the 1-2-th cooking step 220ab into a first-half step 222 and a second-half step 224. Further, the aggregated step candidate calculation unit 464 creates a third candidate 250c by arranging the 2-2-th cooking step 220bb between the first-half step 222 and the second-half step 224. The third candidate 250c can be said to include a further cooking step 220 (2-2-th cooking step 220bb) that uses the same instrument as used in a given cooking step 220 (1-2-th cooking step 220ab) between steps derived from dividing the given cooking step 220 (1-2-th cooking step 220ab). The third candidate 250c includes a third candidate number 253c.

In this case, the cooking time 209 is divided into two equal parts when the 1-2-th cooking step 220ab is divided into the first-half step 222 and the second-half step 224, but the cooking time 209 of the first-half step 222 and the cooking time 209 of the second-half step 224 may be different. To describe it specifically, the aggregated step candidate calculation unit 464 may divide the cooking step 220 such that the integrated value of the cooking time 209 that results when the divisible cooking step 220 is divided is equal to the cooking time 209 that results when the cooking step 220 is not divided. Thereby, the aggregated step data is created such that the integrated value of the cooking time 209 of the steps resulting from dividing the cooking step 220 is equal to the pre-division cooking time 209 of the steps derived from dividing the cooking step 220.

The aggregated step candidate calculation unit 464 calculates the time required for cooking in the first candidate 250a (hereinafter referred to as a “first aggregated step time 259a”) based on the cooking time 209 of the cooking steps 220 in the first candidate 250a. Referring to FIG. 4, the cooking time 209 of the 1-1-th cooking step 220aa is “4 minutes”. Next, the cooking time 209 of the 2-1-th cooking step 220ba is “10 minutes”, and the cooking time 209 of the 1-2-th cooking step 220ab is “20 minutes”. Since these are executed simultaneously and in parallel, the cooking time 209 to complete both the cooking steps 220 is “20 minutes”. The cooking time 209 of the 2-2-th cooking step 220bb is “2 minutes”, and the cooking time 209 of the 2-3-th cooking steps 220bc is “10 minutes”. Integrating the cooking time 209, the first aggregated step time 259a will be “36 minutes”. The first aggregated step time 259a is added to the first candidate 250a of FIG. 4 as associated information.

The aggregated step candidate calculation unit 464 executes a similar process for the second candidate 250b and the third candidate 250c to calculate a second aggregated step time 259b for the second candidate 250b and a third aggregated step time 259c for the third candidate 250c. The second aggregated step time 259b is “34 minutes” as shown in FIG. 5 and is added to the second candidate 250b as associated information. Further, the third aggregated step time 259c is “26 minutes” as shown in FIG. 6 and is added to the third candidate 250c as associated information. The first candidate 250a, the second candidate 250b, and the third candidate 250c are collectively referred to as a candidate 250, and the first aggregated step time 259a, the second aggregated step time 259b, and the third aggregated step time 259c are collectively referred to as an aggregated step time 259.

After completing these processes, the aggregated step candidate calculation unit 464 stores a plurality of candidates 250 in the aggregated step candidate storage unit 440 and outputs a notification indicating that the creation of the candidates 250 of the aggregated step data has been completed (hereinafter referred to as “completion notification”) to the aggregated step selection unit 466. The aggregated step candidate storage unit 440 stores the plurality of candidates 250.

When the aggregated step selection unit 466 receives a completion notification from the aggregated step candidate calculation unit 464, the aggregated step selection unit 466 reads the plurality of candidates 250 stored in the aggregated step candidate storage unit 440. The aggregated step selection unit 466 compares the aggregated step time 259 included in each of the plurality of candidates 250 thus read and selects the shortest aggregated step time 259. The aggregated step selection unit 466 selects the candidate 250 including the selected aggregated step time 259 as the aggregated step data. That is, the candidate 250 having the shortest aggregated step time 259 is selected as the aggregated step data. In this case, the third aggregated step time 259c is 26 minutes and is the shortest so that the third candidate 250c is selected as the aggregated step data. Thus, the processing unit 420 creates aggregated step data comprised of a mixture of the first recipe data 201a and the second recipe data 201b.

The output unit 468 transmits the aggregated step data thus created to the terminal 100 via the communication unit 410 and the network 300. The terminal 100 displays the received aggregated step data on the display unit. Alternatively, the information processing apparatus 400 may display the aggregated step data on a display unit such as a display.

The features are implemented in hardware such as a CPU (Central Processing Unit), a memory, or other LSI's (Large Scale Integration), of any computer and in software such as a program loaded into a memory. The figure depicts functional blocks implemented by the cooperation of these elements. Therefore, it will be understood by those skilled in the art that these functional blocks may be implemented in a variety of manners by hardware only or by a combination of hardware and software.

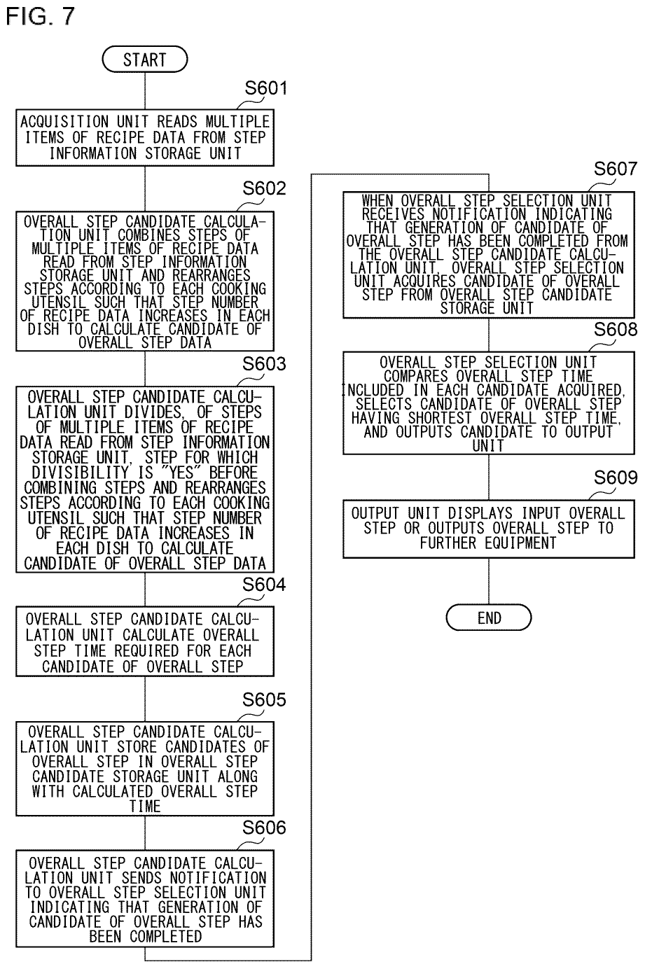

A description will be given of the operation of the information processing system 1000 having the configuration described above. FIG. 7 is a flowchart showing a procedure for creating aggregated step data by the information processing apparatus 400. In step S601, the aggregated step candidate calculation unit 464 reads the first recipe data 201a and the second recipe data 201b from the step information storage unit 430. In step S602, the aggregated step candidate calculation unit 464 combines the cooking steps 220 of a plurality of items of recipe data 201 read from the step information storage unit 430 and rearranges the steps according to each cooking utensil 207 such that the step number 205 of the recipe data 201 increases in each dish to calculate the candidate 250 of the aggregated step data. In step S603, of the cooking steps 220 of the plurality of items of recipe data 201 read from the step information storage unit 430, the aggregated step candidate calculation unit 464 divides the cooking step 220 for which the divisibility 210 is “Yes” before combining the steps and rearranges the steps according to each cooking utensil 207 such that the step number 205 increases in each recipe data 201 to calculate the candidate 250 of the aggregated step data.

In step S604, the aggregated step candidate calculation unit 464 calculates the aggregated step time 259 required for each candidate 250 of the aggregated step data. In step S605, the aggregated step candidate calculation unit 464 stores these candidates 250 of the aggregated step data in the aggregated step candidate storage unit 440 along with the aggregated step time 259 thus calculated. In step S606, the aggregated step candidate calculation unit 464 sends a notification to the aggregated step selection unit 466 indicating that the generation of the candidate 250 of the aggregated step data has been completed. In step S607, when the aggregated step selection unit 466 receives a notification indicating that the generation of the candidate 250 of the aggregated step data has been completed from the aggregated step candidate calculation unit 464, the aggregated step selection unit 466 reads the stored candidate 250 of the aggregated step data from the aggregated step candidate storage unit 440. In step S608, the aggregated step selection unit 466 compares the aggregated step time 259 included in each candidate 250 read, selects the candidate 250 of the aggregated step data having the shortest aggregated step time 259, and outputs the selected candidate 250 to the output unit 468. In step S609, the output unit 468 displays the input aggregated step data or outputs the aggregated step data to a further instrument.

### (Variation 1)

If the cooking time 209 of either the first-half step 222 or the second-half step 224 becomes too short when the cooking step 220 is divided, loading/unloading of a cooking ingredient, etc. occurs in a short period of time, increasing the user's labor. To prevent this, the minimum cooking time 209 resulting from the division may be stored in the divisible cooking step 220. If the cooking time 209 of either the first-half step 222 or the second-half step 224 is shorter than the minimum cooking time 209 when the cooking step 220 is divided, the aggregated step candidate calculation unit 464 does not execute the division of the cooking step 220.

### (Variation 2)

Dividing the divisible cooking step 220 into the first-half step 222 and the second-half step 224 generates extra time in the first-half step 222 or the second-half step 224 for loading/unloading of a cooking ingredient, reheating a cooled cooking ingredient, etc. The aggregated step candidate calculation unit 464 may add extra time when calculating the aggregated step time 259.

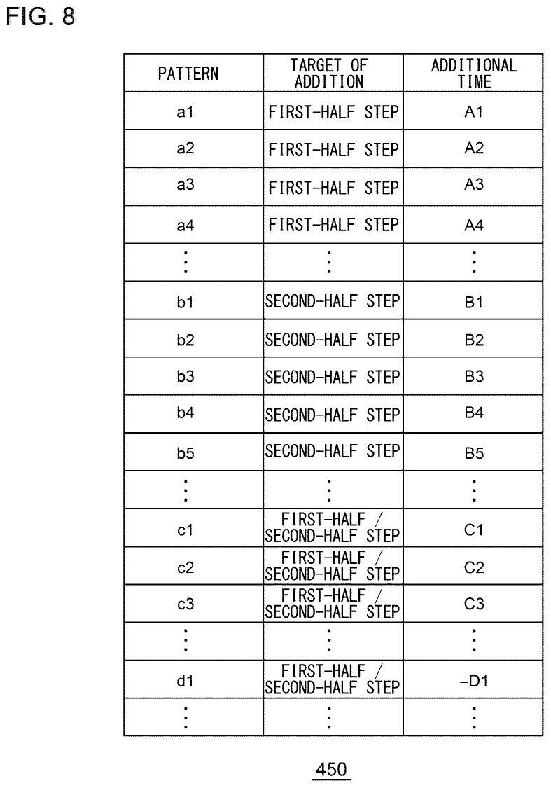

FIG. 8 shows a data structure of a table stored in the table storage unit 450. “Pattern” indicates a situation in which idle time occurs, “target of addition” indicates the first-half step 222 or the second-half step 224 to which idle time should be added, and “additional time” indicates idle time that should be added. The aggregated step candidate calculation unit 464 determines whether the situation that occurs when the divisible cooking step 220 is divided into the first-half step 222 and the second-half step 224 meets any of the patterns shown in the table. If any of the pattern is met, the aggregated step candidate calculation unit 464 adds additional time to the first-half step 222 or the second-half step 224 before calculating the aggregated step time 259.

Patterns a1 to a4 represent, for example, cases where additional time is added to the first-half step 222. Patterns a1 to a4 are exemplified by a step of using an instrument having both oven and microwave oven functions by waiting to use a microwave oven until the instrument is cooled to a certain temperature after it is used an oven, a step of waiting until the amount of water vapor in a cooking utensil is a predetermined value or a predetermined value or less, a step of waiting until the pressure of a cooking utensil is a predetermined value or a predetermined value or less, and a step of opening and closing a cooking utensil.

Patterns b1 to b5 represent, for example, cases where additional time is added to the second-half step 224. Patterns b1 to b5 are exemplified by a step of waiting until the amount of water vapor in a cooking utensil is a predetermined value or a predetermined value or more, a step of waiting until the pressure of a cooking utensil is a predetermined value or a predetermined value or more, a step of waiting until the softness, size, and color of a cooking ingredient is in a predetermined state, a cleaning step, a disinfecting step, or a deodorizing step, and a step of opening or closing a cooking utensil executed before the cooking ingredient to be cooked is input again.

Patterns c1 to c3 represent cases of work that involves human intervention. Patterns c1 to c3 are exemplified by a step required to move or load/unload a cooking ingredient to be cooked, a step required to set a cooking utensil, and a step that allows for a delay time elapsed since it has become possible to proceed to the next step until the next step is actually initiated. The additional step as described above is a step for properly restarting the divided cooking step 220 and may be referred to as a third cooking step. When the cooking time 209 of the aggregated step data created by adding the third cooking step when the cooking step 220 is divided is detected to be longer than the cooking time 209 of the aggregated step data created without dividing the cooking step 220, the latter aggregated step data is output.

Pattern d1 represents a case where the use of a cooking utensil is shortened as a result of division. Pattern d1 indicates a case where a cooking step proceeds during a steaming time, an aging time, etc. in the first-half step 222 or the second-half step 224 even after a cooking ingredient is retrieved from a cooking utensil, and so the cooking time 209 that requires the cooking utensil can be reduced. In this case, the additional time is subtracted from the cooking time 209 of the first-half step 222 or the second-half step 224.

The table shown in FIG. 8 may not be used to add additional time to the first-half step 222 or the second-half step 224. For example, a threshold value(s) for pressure, temperature, etc. at which the cooking utensil can be opened or closed safely may be stored in the table storage unit 450. When it is determined that it is not possible to open or close the cooking utensil safely as a result of comparing the pressure or temperature with the threshold value, the aggregated step candidate calculation unit 464 adds additional time for cooling/reducing the pressure to the first-half step 222 and controls a control valve, etc. to produce a safe state.

Further, the aggregated step candidate calculation unit 464 may add additional time to the second-half step 224 by the following process.
(I) The pre-interruption state (temperature, pressure, water vapor amount, etc.) obtained from the sensor, etc., or the set temperature, etc./set pressure/set water vapor amount at the time of interruption (immediately before the interruption) is maintained. When a deviation from that state by an amount equal to or more than a predefined value is found after the interruption, the aggregated step candidate calculation unit 464 adds additional time to the second-half step 224 and controls the interior of the cooking utensil to return to its original state.

(ii) For example, the set temperature at the time of interruption is maintained. In the case the temperature of the cooking ingredient itself is deviated from the original set temperature by an amount equal to or more than a predefined value when the cooking ingredient is input again, the aggregated step candidate calculation unit 464 adds additional time to the second-half step 224 and heats the cooking ingredient until the temperature is reached.

(iii) When a meat dish and a dessert cookie are being prepared simultaneously, for example, the aroma of meat may impregnate the cookie. When the dish type (maintained in the recipe) is different (“meat dish” and “sweets”), for example, the aggregated step candidate calculation unit 464 adds additional time to the second-half step 224 for deodorization. For the purpose of this process, a flag indicating step separation from other dishes is included in the relevant step, and a determination to insert a cleaning/disinfecting/deodorizing step, etc. is made based on the difference in the type of dish.

### (Variation 3)

It may not be desirable for the user to put in and take out a cooking ingredient frequently for the purpose of shortening the aggregated step time 259 by several minutes. Alternatively, it may be desirable to shorten the aggregated step time 259 although it will increase the amount of work of the user. In such a case, the aggregated step selection unit 466 may select one candidate 250 by considering the amount of work of a person or both the aggregated step time 259 and the amount of work of a person.

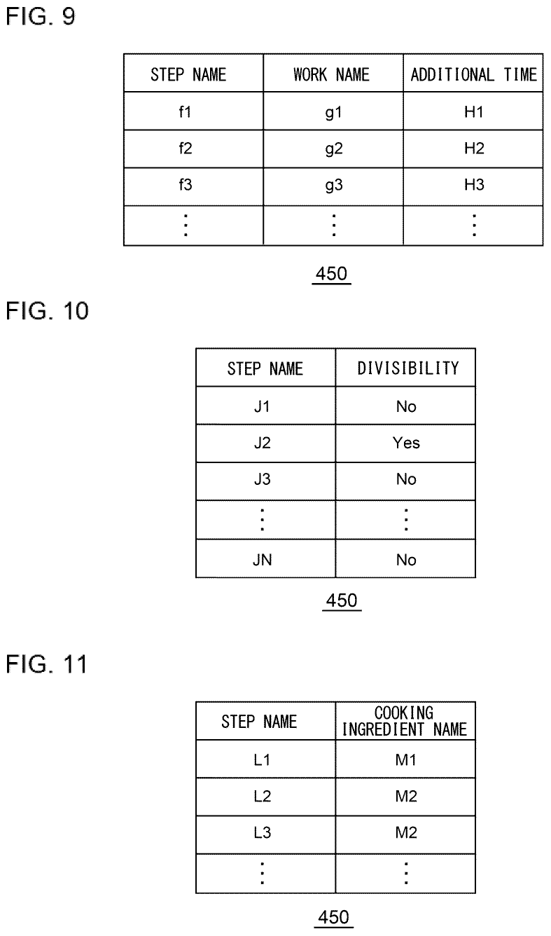

FIG. 9 shows a data structure of a table stored in the table storage unit 450. “Step name” indicates the divisible cooking step 220, “work name” indicates the name of a work performed by the user that could occur when the divisible cooking step 220 is divided, and “additional time” is time derived from converting the amount of work of the user. The aggregated step candidate calculation unit 464 refers to the table when the candidate 250 obtained by dividing the cooking step 220 is created and adds additional time when the cooking step 220 divided is shown in the table.

Alternatively, the table may not be used. For example, the aggregated step candidate calculation unit 464 may calculate the aggregated step time 259 by converting a work of a person into time based on a specific mathematical formula and adding the time in the form of a step. In the case it is necessary to open the door of a cooking utensil after interruption, replace cooking ingredients to be cooked, close the door, and reconfigure the cooking utensil, for example, the aggregated step time 259 may be created after adding a step of 6 minutes, which is derived from adding a time (e.g., 3 minutes) to allow for user fitness for the work to the minimum time of 3 minutes necessary for the actual work, to the post-interruption aggregated step, instead of adding the minimum time actually required for the work to the aggregated step.

### (Variation 4)

Whether the cooking step 220 is divisible is determined based on the divisibility 210 assigned to the cooking step 220. However, the divisibility 210 may not be assigned to the cooking step 220. FIG. 10 shows a data structure of a table stored in the table storage unit 450. As shown, the table shows the divisibility of the cooking steps 220. When creating the candidate 250, the aggregated step candidate calculation unit 464 refers to the table to determine whether the step is divisible. The table including information on divisibility may be generated based on the fact that the user has actually decided to execute the division.

Further, a determination as to divisibility may be made according to whether it is possible to restore a state at the time of interruption or to a post-interruption state in which cooking step has proceeded. In the case it is necessary to keep the internal temperature at 80° C. for 30 minutes in a particular cooking step, a determination may be made that the step is divisible provided that there is a means to raise the internal temperature to 80° C. by reheating even if the internal temperature has cooled to 35° C. due to interruption. Whether restoration is possible can be determined by searching predefined restoration steps for a step that can be executed for restoration. FIG. 11 shows a data structure of another table stored in the table storage unit 450. The table lists combinations of cooling steps 220 and cooking ingredients for which restoration is difficult. When the cooking step 220 for which the candidate 250 is sought to be created and the name the cooking ingredient are included in the table, the aggregated step candidate calculation unit 464 determines that the cooking step 220 is not divisible.

The cooking step 220 may lack a step name. For example, this occurs in a case where it is possible to cook without the step name and merely by using information such as the cooking utensil 207, the cooking intensity 208, the cooking time 209. In such a case, it is not possible to directly determine divisibility by referring to the step name using the table. On the other hand, the normal recipe data 201 may be accompanied by a procedure manual assumed to be read by a person. In that case, it is possible to obtain information equivalent to the step name of the cooking step 220 by seeking correlation between each cooking step 220 of the recipe data 201 and the text in the procedure manual. Since known technology may be used for natural language processing and correlation seeking, a description is omitted here.

In the case of the first recipe data 201a, for example, the procedure manual includes the following description.
1. Cut a carrot, lotus root, and konjac.
2. Put them in a bowl and simmer them in a microwave oven at 400 W for 20 minutes.

In this case, it is recognized by natural language processing that the cooking step 220 with the step number 205 of 1 corresponds to “1.” in the document, and the cooking step 220 with the step number 205 of 2 corresponds to “2.” in the document. It is also recognized that the name of the cooking step 220 executed is “cut” in the case of “1.” and “simmer” in the case of “2.”. Alternatively, the table of FIG. 11 may be checked based on the step name “cut” or “simmer” to determine divisibility.

### (Variation 5)

The aggregated step candidate calculation unit 464 of the embodiment rearranges the cooking steps 220 such that the use of the cooking utensil 207 does not concur with each other. This is because it is rare to have a plurality of the same cooking utensils, and the same cooking utensil cannot be used in a plurality of cooking steps 220 during the same time period. However, there may be cases where the number of people available for cooking is insufficient in a step(s) that involves human intervention. While it is possible to execute steps using, as the cooking utensil 207, a “kitchen knife” and a “bowl” simultaneously and in parallel when the number of persons available for work is 2 or more, the steps cannot be executed simultaneously and in parallel when the number of persons available for work is 1. In order to address this issue, those of the cooking steps 220 in the recipe data 201 that involve human intervention includes a “human intervention” flag. The aggregated step candidate calculation unit 464 creates the candidate 250 such that the number of cooking steps 220 having the flag does not exceed a preset number of people available for work within the same time period. Further, when the cooking step 220 having the flag is included in the recipe data 201, the aggregated step candidate calculation unit 464 may check whether the cooking step 220 is divisible.

### (Variation 6)

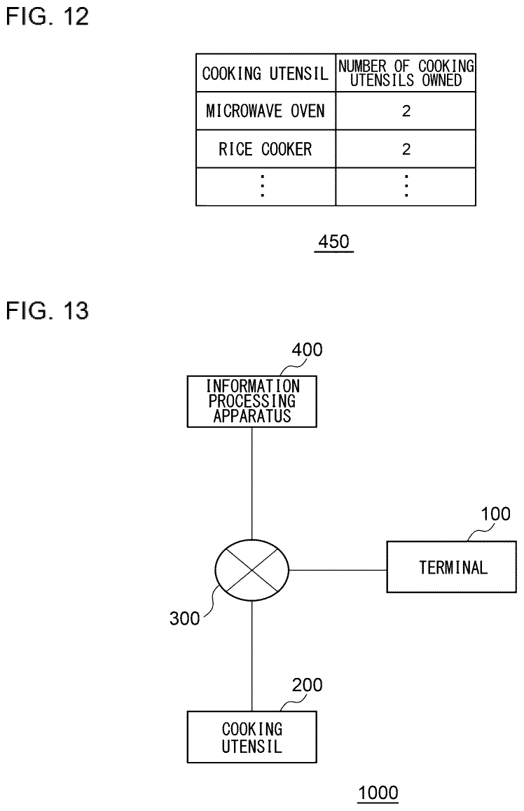

When the user owns a plurality of the same cooking utensils, the aggregated step candidate calculation unit 464 may create the candidate 250 reflecting the fact. FIG. 12 shows a data structure of another table stored in the table storage unit 450. The correspondence between the cooking utensil 207 and the number of cooking utensils owned is stored. The aggregated step candidate calculation unit 464 refers to the table and creates the candidate 250 such that the number of cooking utensils owned does not exceed the number of simultaneous uses.

Further, the aggregated step candidate calculation unit 464 may create the candidate 250 to prevent cases of non-assignment from occurring, checking which cooking utensil 207 is assigned to the cooking step 220. For example, an oven range and a toaster oven are different cooking utensils 207, but both can be used for a step of “baking”. When both of the cooking utensils 207 are available for use, therefore, it is possible to execute two separate steps of “baking” simultaneously, and so the aggregated step candidate calculation unit 464 may create such a candidate 250.

### (Variation 7)

FIG. 13 shows a configuration of the information processing system 1000. As compared to the system of FIG. 1, the information processing system 1000 further includes a cooking utensil 200. The number of cooking utensils 200 is not limited to “1”. The cooking utensil 200 is, for example, a rice cooker, a microwave oven, and an automatic cooking utensil. The cooking utensil 200 has a communication function and is connected to the information processing apparatus 400 via the network 300. The output unit 468 of the information processing apparatus 400 transmits the aggregated step data to the cooking utensil 200 via the communication unit 410 and the network 300. In that process, the aggregated step data may be converted into a format that can be processed by the cooking utensil 200. When the cooking utensil 200 receives the aggregated step data, the cooking utensil 200 executes the cooking step 220 relevant to itself.

According to this embodiment, the candidate 250 is created by dividing the divisible cooking step 220 so that the candidate 250 with a short aggregated step time 259 can be created. Further, the candidate 250 with the shortest aggregated step time 259 is selected as the aggregated step data so that the overall cooking time can be shortened in the case of cooking according to a plurality of recipes. In addition, electricity bills can be saved in the case of a dish, such as simmered foods that take a long time to cook, that can be left unattended for cooking to proceed without necessarily being heated continuously. Further, the cooking step 220 of grilling a steak meat is interrupted temporarily, and another cooking step 220 is executed before returning to the cooking step 220 of grilling the meat. Therefore, the dish can be served in a warmer condition. Further, a confirmation is made as to the divisibility of the cooking step 220 when the same cooking utensil 207 is used in a plurality of cooking steps 220 so that the divisible cooking step 220 can be detected easily.

Further, the cooking step 220 is determined to be a divisible cooking step 220 when the cooked food is not so deteriorated so much if the cooking step 220 is interrupted. Accordingly, deterioration of the cooked product can be suppressed even if the aggregated step time 259 is shortened. Further, the cooking step 220 is determined to be a divisible cooking step 220 provided that, assuming that the cooking step 220 is interrupted, the cooked food can be finished to a complete state that meets a predetermined standard once the entire cooking step 220 is completed. Accordingly, deterioration of the cooked product can be suppressed even if the aggregated step time 259 is shortened.

Further, the cooking step 220 of the next step number 205 cannot be executed until the cooking step 220 of the previous step number 205 is completed so that a situation in which the order of the cooking step 220 is changed is prevented. Further, the cooking steps 220 are organized according to each cooking utensil 207 before arranging the cooking steps 220 such that the step number 205 increases in the recipe data 201. Accordingly, the candidate 250 can be created easily. Further, the cooking step 220 is organized according to each cooking utensil 207 so that the usage efficiency of the cooking utensil 207 is improved.

Further, the divisible cooking step 220 is divided such that such that the integrated value of the cooking time 209 that results when the divisible cooking step 220 is divided is equal to the cooking time 209 that results when the divisible cooking step 220 is not divided. Accordingly, the flexibility of division is improved. Further, the minimum cooking time 209 resulting from the division is stored in association with the divisible cooking step so that the minimum divided time is defined in advance. Further, the minimum divided time is determined in advance so that it is possible to properly maintain an equilibrium between reduction of the cooking step 220 and increase, due to the division, in man-hours for loading/unloading of a cooking ingredient. Further, time required as a result of dividing the cooking step 220 is added to the first-half step 222 or the second-half step 224 so that the accuracy of the aggregated step time 259 is improved.

A summary of an embodiment of the present disclosure is given below. An information processing method according to an embodiment of the present disclosure includes: acquiring a plurality of first cooking steps and a plurality of second cooking steps; and outputting, based on an instrument used in the plurality of first cooking steps and the plurality of second cooking steps, aggregated step data indicating an aggregated step comprised of a mixture of the plurality of first cooking steps and the plurality of second cooking steps such that an overall cooking time is shorter than a total of a step comprised of a combination of the plurality of first cooking steps and the plurality of second cooking steps, wherein the aggregated step includes, between steps derived from dividing a given first cooking step, a second cooking step that uses the same instrument as the given first cooking step.

Those of the plurality first cooking steps the plurality of second cooking steps in which the same instrument is used are subject to a determination as to whether division is possible.

Each of the plurality of first cooking steps and the plurality of second cooking steps includes a step number indicating an order of execution of cooking, and the cooking step with the step number n is prevented from being executed until the cooking step with the step number (n−1) is completed, wherein n is an integer equal to or larger than 1.

The aggregated step is created by: organizing each of the plurality of first cooking steps and the plurality of second cooking steps according to each instrument used; and arranging the cooking steps such that the step number increases in each of the plurality of first cooking steps and the plurality of second cooking steps.

The aggregated step is created by: ensuring that an integrated value of a cooking time of steps derived from dividing the first cooking step is equal to a pre-division cooking time of the steps derived from dividing the first cooking step.

The minimum cooking time into which the cooking step is divisible is stored in association with the cooking step, of the plurality of first cooking steps and the plurality of second cooking steps, that is divisible.

The aggregated step is created by: adding, before and after the second cooking step included between the steps derived from dividing the given first cooking step, a third cooking step that restarts the first cooking step, which is divided, properly.

The third cooking step is added to the aggregated step, and a cooking time of a resultant aggregated step is detected to be longer than a cooking time of the aggregated step created without dividing the given first cooking step, and the aggregated step data created without dividing the given first cooking step is output.

Another embodiment of the present disclosure also relates to an information processing apparatus. The apparatus includes: an acquisition unit that acquires first recipe data indicating a plurality of first cooking steps and second recipe data indicating a plurality of second cooking steps; and an output unit that outputs, based on an instrument used in the plurality of first cooking steps and the plurality of second cooking steps, aggregated step data indicating an aggregated step comprised of a mixture of the plurality of first cooking steps and the plurality of second cooking steps such that an overall cooking time is shorter than a total of a step comprised of a combination of the plurality of first cooking steps and the plurality of second cooking steps. The aggregated step includes, between steps derived from dividing a given first cooking step, a second cooking step that uses the same instrument as the given first cooking step.

The present disclosure has been described above based on an exemplary embodiment. The exemplary embodiment intended to be illustrative only and it will be understood by those skilled in the art that various modifications to combinations of constituting elements and processes are possible and that such modifications are also within the scope of the present disclosure.

What is claimed is:

1. An information processing method comprising:
acquiring a plurality of first cooking steps and a plurality of second cooking steps; and
outputting, based on an instrument used in the plurality of first cooking steps and the plurality of second cooking steps, aggregated step data indicating an aggregated step comprised of a mixture of the plurality of first cooking steps and the plurality of second cooking steps such that an overall cooking time is shorter than a total of a step comprised of a combination of the plurality of first cooking steps and the plurality of second cooking steps,
wherein the aggregated step includes, between steps derived from dividing a given first cooking step, a second cooking step that uses the same instrument as the given first cooking step.

2. The information processing method according to claim 1,
wherein those of the plurality first cooking steps the plurality of second cooking steps in which the same instrument is used are subject to a determination as to whether division is possible.

3. The information processing method according to claim 2,
wherein each of the plurality of first cooking steps and the plurality of second cooking steps includes a step number indicating an order of execution of cooking, and the cooking step with the step number n is prevented from being executed until the cooking step with the step number (n−1) is completed, and
wherein n is an integer equal to or larger than 1.

4. The information processing method according to claim 3,
wherein the aggregated step is created by:
organizing each of the plurality of first cooking steps and the plurality of second cooking steps according to each instrument used; and
arranging the cooking steps such that the step number increases in each of the plurality of first cooking steps and the plurality of second cooking steps.

5. The information processing method according to claim 2,
wherein the aggregated step is created by:
ensuring that an integrated value of a cooking time of steps derived from dividing the first cooking step is equal to a pre-division cooking time of the steps derived from dividing the first cooking step.

6. The information processing method according to claim 5,
wherein, the minimum cooking time into which the cooking step is divisible is stored in association with the cooking step, of the plurality of first cooking steps and the plurality of second cooking steps, that is divisible.

7. The information processing method according to claim 2,
wherein the aggregated step is created by:
adding, before and after the second cooking step included between the steps derived from dividing the given first cooking step, a third cooking step that restarts the first cooking step, which is divided, properly.

8. The information processing method according to claim 7,
wherein the third cooking step is added to the aggregated step, and a cooking time of a resultant aggregated step is detected to be longer than a cooking time of the aggregated step created without dividing the given first cooking step, and the aggregated step data created without dividing the given first cooking step is output.

9. An information processing apparatus comprising:
an acquisition unit that acquires first recipe data indicating a plurality of first cooking steps and second recipe data indicating a plurality of second cooking steps; and
an output unit that outputs, based on an instrument used in the plurality of first cooking steps and the plurality of second cooking steps, aggregated step data indicating an aggregated step comprised of a mixture of the plurality of first cooking steps and the plurality of second cooking steps such that an overall cooking time is shorter than a total of a step comprised of a combination of the plurality of first cooking steps and the plurality of second cooking steps,
wherein the aggregated step includes, between steps derived from dividing a given first cooking step, a second cooking step that uses the same instrument as the given first cooking step.

10. A program comprising modules including:
a module that causes first recipe data indicating a plurality of first cooking steps and second recipe data indicating a plurality of second cooking steps to be acquired; and
a module that causes, based on an instrument used in the plurality of first cooking steps and the plurality of second cooking steps, aggregated step data indicating an aggregated step comprised of a mixture of the plurality of first cooking steps and the plurality of second cooking steps such that an overall cooking time is shorter than a total of a step comprised of a combination of the plurality of first cooking steps and the plurality of second cooking steps to be output,
wherein the aggregated step includes, between steps derived from dividing a given first cooking step, a second cooking step that uses the same instrument as the given first cooking step.
